(19) United States
(12) Patent Application Publication
(10) Pub. No.: US 2026/0066315 A1
(43) Pub. Date: Mar. 5, 2026

(54) FUEL CELL EXHAUST GAS INSTALLATION, FUEL CELL SYSTEM, AND METHOD FOR REDUCING THE WATER CONTENT IN FUEL CELL EXHAUST GAS

(71) Applicant: Purem GmbH, Neunkirchen (DE)

(72) Inventors: Arnulf Spieth, Hochdorf (DE); Enver Kurpejovic, Kirchheim unter Teck (DE)

(21) Appl. No.: 19/259,999

(22) Filed: Jul. 3, 2025

(30) Foreign Application Priority Data
Jul. 5, 2024 (DE) 10 2024 119 112.0

(51) Int. Cl. H01M 8/04119; B60R 16/033

(52) U.S. Cl. CPC H01M 8/04164; B60R 16/033; H01M 2220/20

(57) ABSTRACT

A fuel cell exhaust gas installation for a fuel cell system includes a mixing arrangement for collecting fuel cell exhaust gas emitted from at least one fuel cell of a fuel cell system and for collecting a mixed gas and for producing a mixture of fuel cell exhaust gas and mixed gas and a water separation arrangement in the area of the mixing arrangement and/or downstream of the mixing arrangement for separating water condensed from the mixture and for discharging the mixture. The fuel cell exhaust gas installation is also for a fuel cell system in a vehicle.

### CROSS-REFERENCE TO RELATED APPLICATIONS

This application claims priority of German patent application no. 10 2024 119 112.0, filed Jul. 5, 2024, the entire content of which is incorporated herein by reference.

### TECHNICAL FIELD

The present disclosure relates to a fuel cell exhaust gas installation, a fuel cell system including such a fuel cell exhaust gas installation and a method for reducing the water content in the fuel cell exhaust gas emitted from a fuel cell of a fuel cell system.

### BACKGROUND

When generating electrical energy in a fuel cell system constructed with one or more PEM fuel cells, for example, water is produced, particularly in the cathode section. This is generally carried along as water vapor in the cathode exhaust gas leaving the cathode section, which essentially provides the fuel cell exhaust gas to be discharged into the environment, and is discharged into the environment via a fuel cell exhaust gas installation. Particularly at a comparatively low ambient temperature, mist forms when fuel cell exhaust gas heavily enriched with water vapor is discharged into the ambient air due to the spontaneous drop in temperature of the fuel cell exhaust gas on contact with the ambient temperature as a result of condensing water. This can impair visibility in the vicinity of a vehicle equipped with such a fuel cell system and can also lead to ice formation on the ground in the region of a vehicle equipped with such a fuel cell system.

### SUMMARY

An object of the present disclosure is to provide a fuel cell exhaust gas installation, a fuel cell system constructed therewith, and a method for reducing the water content in fuel cell exhaust gas, which, with a simple configuration, prevents the discharge of fuel cell exhaust gas leading to a heavy mist formation into the environment.

According to a first aspect of the present disclosure, this object is achieved by a fuel cell exhaust gas installation for a fuel cell system, in particular in a vehicle, including:
a mixing arrangement for collecting fuel cell exhaust gas emitted from at least one fuel cell of a fuel cell system and for collecting a mixed gas and for producing a mixture of fuel cell exhaust gas and mixed gas,
a water separation arrangement in the area of the mixing arrangement and/or downstream of the mixing arrangement for separating water condensed from the mixture and for discharging the mixture.

By introducing the thermally essentially untreated, generally therefore comparatively cold, ambient air into the fuel cell exhaust gas, that is, by combining these two gas streams, it can be ensured that a larger proportion of the water vapor contained in the fuel cell exhaust gas is condensed out already in the fuel cell exhaust gas installation in the area of the water separation arrangement. As a result, due to the significantly lower water content in the fuel cell exhaust gas leaving the fuel cell exhaust gas installation, a mist will essentially not form even at a comparatively low ambient temperature.

For producing and further processing the mixture, it is possible to provide:
that the mixing arrangement includes a first mixing arrangement inlet region for collecting fuel cell exhaust gas in the mixing arrangement,
that the mixing arrangement includes a second mixing arrangement inlet region for collecting mixed gas in the mixing arrangement,
that the mixing arrangement includes a mixing volume for mixing the fuel cell exhaust gas with the mixed gas and for producing the mixture,
that the mixing arrangement includes a mixing arrangement outlet region for discharging the mixture.

In order to be able to introduce a defined quantity of mixed gas into the fuel cell exhaust gas, in other words to be able to mix it with the fuel cell exhaust gas, it is possible to provide a mixed gas supply arrangement for supplying mixed gas to the mixing arrangement.

In the case of an actively operating mixed gas supply arrangement, the mixed gas supply arrangement can include a fan or a compressor.

In the case of a particularly simple configuration, both in terms of construction and the control measures required, a passively operating mixed gas supply arrangement can include a jet pump arrangement, wherein the fuel cell exhaust gas forms a propellant medium and the mixed gas forms a suction medium.

For providing this passively operating structure of the mixed gas supply arrangement, the jet pump arrangement can include an upstream pipe section for introducing the fuel cell exhaust gas and a downstream pipe section, wherein the upstream pipe section is positioned engaging with a downstream end region in an upstream end region of the downstream pipe section, wherein an inlet region for the mixed gas is formed, preferably surrounding the downstream end region of the upstream pipe section in an annular manner, between the downstream end region of the upstream pipe section and the upstream end region of the downstream pipe section.

In order to support the mixing by accelerating the gas streams, it is proposed that the upstream pipe section is tapered in its downstream end region in the direction of flow, and/or that the downstream pipe section is tapered in its upstream end region.

If the mixed gas supply arrangement is configured for supplying ambient air as mixed gas to the mixing arrangement, the medium into which the water-depleted mixture of fuel cell exhaust gas and mixed gas is to be discharged can also be used as mixed gas. Since the ambient air used as mixed gas essentially has the temperature when it is introduced into the fuel cell exhaust gas to which the mixture is cooled after the separation of water, the separation of water in the fuel cell exhaust gas installation is supported, which efficiently reduces mist formation when the mixture is discharged into the environment.

In order to mix the fuel cell exhaust gas efficiently with the mixed gas, a mixer can be arranged upstream of the introduction of the mixed gas into the fuel cell exhaust gas and/or downstream of the introduction of the mixed gas into the fuel cell exhaust gas. Such a mixer can be configured, for example, with a plurality of blade-like deflecting elements in order to generate turbulence in the flow or a swirl flow, for example of the fuel cell exhaust gas.

The water separation arrangement can include a water-collecting volume and a separation arrangement outlet region for discharging water from the water-collecting volume.

According to a further aspect of the present disclosure, the object mentioned at the beginning is achieved by a fuel cell system, in particular in a vehicle, including:
at least one fuel cell with an anode section to be supplied with hydrogen-including anode gas and a cathode section to be supplied with oxygen-including cathode gas,
a fuel cell exhaust gas installation constructed in accordance with the disclosure, wherein the mixing arrangement for collecting fuel cell exhaust gas discharged at the cathode section of the at least one fuel cell is connected to the cathode section.

According to a further aspect of the present disclosure, the object mentioned at the beginning is achieved by a method for reducing the water content in fuel cell exhaust gas generated in a fuel cell system, including the following measures:
a) introducing a mixed gas into the fuel cell exhaust gas and producing a mixture of fuel cell exhaust gas and mixed gas,
b) separating water from the mixture,
c) discharging the mixture from which the water has been removed during measure b) into the environment.

In the case of this method, measure a) includes supplying the fuel cell exhaust gas to a mixing volume of a mixing arrangement and supplying the mixed gas to the mixing volume.

For efficient removal of the condensed water, measure b) can include collecting water condensed from the fuel cell exhaust gas in a water-collecting volume and discharging the water collected in the water-collecting volume.

In order to sufficiently lower the temperature of the fuel cell exhaust gas already in the fuel cell exhaust gas installation for efficient separation of water from it, it is proposed that, in measure a), ambient air as mixed gas be mixed with the fuel cell exhaust gas.

The ambient air can be supplied, for example, via a mixed gas supply arrangement.

The method in accordance with the disclosure is advantageously performed via a fuel cell exhaust gas installation constructed in accordance with the disclosure in a fuel cell system constructed in accordance with the disclosure and including this.

### BRIEF DESCRIPTION OF DRAWINGS

The invention will now be described with reference to the drawings wherein:

FIG. 1 shows a representation in principle of a fuel cell system with a fuel cell exhaust gas installation;

FIG. 2 shows a mixing arrangement of the fuel cell exhaust gas installation of FIG. 1 with an actively operating mixed gas supply arrangement; and,

FIG. 3 shows a mixing arrangement of the fuel cell exhaust gas installation of FIG. 1 with a passively operating mixed gas supply arrangement.

### DETAILED DESCRIPTION

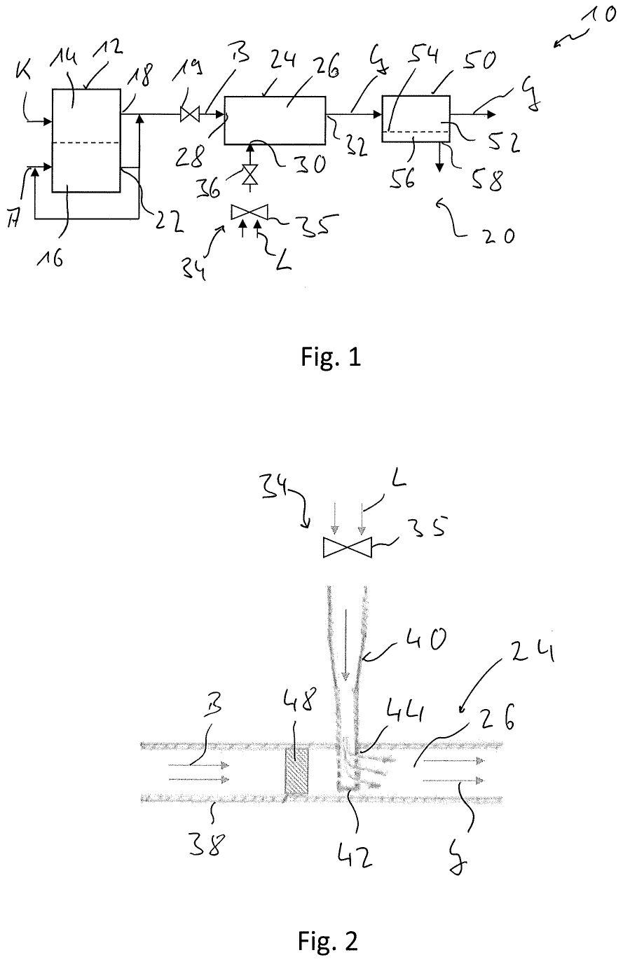

In FIG. 1, a fuel cell system provided, for example, for generating electrical energy in a vehicle is generally designated 10. The fuel cell system 10 includes a fuel cell 12 configured, for example, as a fuel cell stack or the like and including a cathode section 14 and an anode section 16. A cathode gas K, for example air, including oxygen is supplied to the cathode section 14 by a compressor or the like. An anode gas A including hydrogen (H₂) is supplied to the anode section 16.

A cathode exhaust gas occurring in the fuel cell process exits the cathode section 14 at a cathode section outlet region 18 and flows, for example, via a valve 19, which can be selectively shut off, in the direction of a fuel cell exhaust gas installation generally designated 20. Anode exhaust gas escaping from an anode section outlet region 22, for example during a purge process, can be recycled into the working process in order to be able to use the hydrogen contained therein to generate electrical energy, and/or can be fed together with the cathode exhaust gas as fuel cell exhaust gas B to the fuel cell exhaust gas installation 20.

During the fuel cell operation, water is produced, particularly in the cathode section 14, and is generally carried along as water vapor in the cathode exhaust gas, which mainly includes oxygen and nitrogen. The content of water or water vapor in the cathode exhaust gas can be comparatively high and almost complete saturation, in other words a relative moisture of 100%. If such cathode exhaust gas enriched with water or water vapor is discharged into the environment as fuel cell exhaust gas B, there is a risk that, especially at a comparatively low ambient temperature, water will condense when the fuel cell exhaust gas B comes into contact with the cold ambient air, thus forming mist.

In order to eliminate as far as possible the risk of mist formation during the discharge of fuel cell exhaust gas B in the case of the fuel cell exhaust gas installation 20 shown in FIG. 1 or in the case of the fuel cell system 10 including this, the fuel cell exhaust gas installation 20 includes a mixing arrangement 24 with a mixing volume 26 formed, for example, in a housing. The fuel cell exhaust gas B emitted from the fuel cell 12 is introduced into the mixing volume 26 via a first mixing arrangement inlet region 28. A mixed gas L is introduced into the mixing volume 26 via a second mixing arrangement inlet region 30 in order to mix it with the fuel cell exhaust gas B and thereby produce a mixture G of fuel cell exhaust gas B and mixed gas L which leaves the mixing arrangement 24 at a mixing arrangement outlet region 32.

A mixed gas supply arrangement generally designated 34 is provided for supplying the mixed gas L to the mixing arrangement 24. In a configuration shown in FIGS. 1 and 2, the mixed gas supply arrangement 34 is configured as an actively operating system and includes, for example, a fan or a compressor 35 in order to feed ambient air from the vicinity of the fuel cell exhaust gas installation 20 or a vehicle containing this, as mixed gas L, for example via a valve 36, which can be selectively opened or shut off, into the mixing volume 26.

A mixing arrangement 24 constructed with such an actively operating mixed gas supply arrangement 34 is illustrated in FIG. 2. The mixing arrangement 24 includes, for example, a tubular housing 38 into which the fuel cell exhaust gas B is introduced. A gas/gas mixer, generally designated 40, is provided for supplying the ambient air as mixed gas L, the mixed gas L being introduced into the gas/gas mixer by the fan or compressor 35 of the mixed gas supply arrangement 34. The gas/gas mixer 40 includes a gas discharge region 42, which extends within the tubular housing 38 and includes a plurality of mixed gas discharge openings 44. The mixed gas L passes through the mixed gas discharge openings 44 into a mixing volume 26 formed in the tubular housing 38 downstream of the point where the mixed gas L is introduced into the fuel cell exhaust gas B, the mixture G of fuel cell exhaust gas B and mixed gas L being formed in the mixing volume.

In order to support the mixing of fuel cell exhaust gas B with the mixed gas L in the mixing volume 26, a mixer 48 is provided upstream of the point at which mixed gas L is introduced into fuel cell exhaust gas B in the construction of the mixing arrangement 24 shown in FIG. 2. The mixer 48 can, for example, include a plurality of blade-like deflecting elements that deflect the flow of the fuel cell exhaust gas B in the circumferential direction so that turbulence or a swirl flow is generated in the fuel cell exhaust gas B, into which the mixed gas L then enters.

Downstream of the mixing volume 26 of the mixing arrangement 24, a water separation arrangement generally designated 50 is provided. The water separation arrangement 50 includes a volume 52 through which the mixture G can flow and from which a water-collecting volume 56 is separated, for example by a wall 54 provided with openings.

The fuel cell exhaust gas B leaving the fuel cell 12 is greatly enriched with water or water vapor and has a relative moisture of almost 100%. In the mixing volume 26, this fuel cell exhaust gas B, which is heavily saturated with water and has a temperature of up to approximately 100° C., is mixed with the ambient air used as mixed gas L, which, since it is not subjected to any significant thermal treatment prior to being introduced into the mixing volume 26, is at ambient temperature. Particularly at comparatively low ambient temperatures, the mixing of fuel cell exhaust gas B, which is almost completely saturated with water vapor, with the comparatively cold ambient temperature causes the mixture G thus produced to have a significantly lower temperature than the fuel cell exhaust gas B. This causes the relative humidity to increase to 100%. Since this state cannot be exceeded, water condenses out of mixture G and is carried along in mixture G in the form of water droplets, for example, and precipitates in the area of the water separation arrangement 50, for example due to a flow deceleration occurring there, and accumulates in the area of the water-collecting volume 56. At a separation arrangement outlet region 58, the water accumulated in the water-collecting volume 56 can be discharged either continuously or intermittently and, for example, fed back into the fuel cell process or discharged into the environment.

The mixture G from which the water has been removed then leaves the water separation arrangement 50 and can, for example, be discharged directly into the environment. Since the water content of the mixture G leaving the fuel cell exhaust gas installation 20 is significantly reduced compared to the water content of the fuel cell exhaust gas B, no or virtually no water will condense when the mixture G comes into contact with the ambient air, so that mist formation can be largely avoided.

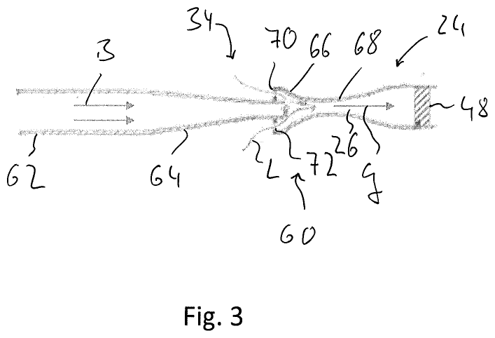

An alternative configuration of the mixed gas supply arrangement 34 is shown in FIG. 3. The mixed gas supply arrangement 34 of FIG. 3 is a passively operating system and includes a jet pump arrangement 60. The jet pump arrangement 60 includes an upstream pipe section 62 via which the fuel cell exhaust gas B is introduced into the mixing arrangement 24. The upstream pipe section 62 has a downstream end region 64 which tapers in the direction of flow, in other words has a reducing flow cross section, and is positioned for engaging in an upstream end region 66 of a downstream pipe section 68. The upstream end region 66 of the downstream pipe section 68 tapers in the direction of flow, in other words with a decreasing flow cross section.

The upstream end region 66 of the downstream pipe section 68 is essentially open, so that a ring-shaped inlet region 70 for the mixed gas L is formed around the downstream end region 64 of the upstream pipe section 62. For example, the ring-shaped inlet region 70 can include a plurality of mixed gas inlet openings 72 arranged in succession in the circumferential direction around the downstream end region 64.

In the case of this jet pump arrangement 60, the fuel cell exhaust gas B provides a propellant medium which, when flowing into the upstream end region 66 of the downstream pipe section 68, generates a negative pressure in the area of the inlet region 70 due to its comparatively high flow velocity and thereby draws in the ambient air used as mixed gas L.

The mixture G consisting of fuel cell exhaust gas B and mixed gas L is formed in the mixing volume 26 following the inlet region 70 in the direction of flow. In order to support this mixing, a mixer 48 that generates turbulence or a swirling flow can be provided. While in the case of the embodiment shown in FIG. 2 with an actively operating mixed gas supply arrangement 34 the mixer 48 is advantageously arranged upstream of the gas/gas mixer 40 in order to introduce the mixed gas L into a turbulent flow or a swirl flow of the fuel cell exhaust gas B, in the case of the passively operating mixed gas supply arrangement 34 shown in FIG. 3, the mixer 48 is advantageously provided downstream of the introduction of the mixed gas L into the fuel cell exhaust gas B in order to avoid impairing the effect of the jet pump arrangement 60.

Also in the case of the mixing arrangement 24 shown in FIG. 3, the mixture G formed in the mixing volume 26 then flows to a water separation arrangement in order to separate out water that condenses during mixing with the mixed gas L in the cooling that occurs.

It should be noted that the fuel cell exhaust gas installation can also be configured in a different way than shown in FIG. 1. For example, the mixing arrangement 24 and the water separation arrangement 50 can be combined structurally and housed in a housing. For example, the mixing volume 26 can also simultaneously form the part or a part of the volume 52 of the water separation arrangement 50 through which the mixture G can flow, in order also to collect and discharge water W that condenses and precipitates from the mixture G immediately during the mixing of fuel cell exhaust gas B and mixed gas L already in the area of the mixing volume 26. The fuel cell exhaust gas installation can also include further system areas, such as a silencer or the like, for example downstream of the mixing arrangement or the water separation arrangement, so that the mixture G is not discharged from the water separation arrangement 50 directly into the environment, but via such further system areas.

It is understood that the foregoing description is that of the preferred embodiments of the invention and that various changes and modifications may be made thereto without departing from the spirit and scope of the invention as defined in the appended claims.

1. A fuel cell exhaust gas installation for a fuel cell system, the fuel cell exhaust gas installation comprising:
a mixing arrangement for collecting fuel cell exhaust gas emitted from at least one fuel cell of a fuel cell system and for collecting a mixed gas and for producing a mixture of fuel cell exhaust gas and mixed gas; and,
a water separation arrangement for separating water condensed from said mixture and for discharging said mixture; and,
said water separation arrangement being disposed at least one of in an area of the mixing arrangement and downstream of said mixing arrangement.

2. The fuel cell exhaust gas installation of claim 1, wherein:
said mixing arrangement includes a first mixing arrangement inlet region for collecting fuel cell exhaust gas in said mixing arrangement;
said mixing arrangement includes a second mixing arrangement inlet region for collecting mixed gas in said mixing arrangement;
said mixing arrangement includes a mixing volume for mixing the fuel cell exhaust gas with the mixed gas and for producing the mixture; and,
said mixing arrangement includes a mixing arrangement outlet region for discharging the mixture.

3. The fuel cell exhaust gas installation of claim 1, wherein a mixed gas supply arrangement is provided so as to supply mixed gas to said mixing arrangement.

4. The fuel cell exhaust gas installation of claim 3, wherein said mixed gas supply arrangement includes a fan or a compressor.

5. The fuel cell exhaust gas installation of claim 3, wherein said mixed gas supply arrangement includes a jet pump arrangement, wherein the fuel cell exhaust gas forms a propellant medium and the mixed gas forms a suction medium.

6. The fuel cell exhaust gas installation of claim 5, wherein said jet pump arrangement includes an upstream pipe section for introducing the fuel cell exhaust gas and a downstream pipe section, wherein the upstream pipe section is positioned for engaging with a downstream end region in an upstream end region of said downstream pipe section, wherein an inlet region for the mixed gas is formed surrounding said downstream end region of said upstream pipe section in an annular manner, between said downstream end region of the upstream pipe section and said upstream end region of said downstream pipe section.

7. The fuel cell exhaust gas installation of claim 6, wherein at least one of the following applies:
i) said upstream pipe section is tapered at the downstream end region in a direction of flow; and,
ii) the downstream pipe section is tapered at the upstream end region.

8. The fuel cell exhaust gas installation of claim 3, wherein said mixed gas supply arrangement is configured for supplying ambient air as mixed gas to the mixing arrangement.

9. The fuel cell exhaust gas installation of claim 1, wherein at least one of the following applies:
i) a mixer is arranged upstream of the introduction of the mixed gas into the fuel cell exhaust gas; and,
ii) a mixer is arranged downstream of the introduction of the mixed gas into the fuel cell exhaust gas.

10. The fuel cell exhaust gas installation of claim 1, wherein said water separation arrangement includes a water-collecting volume and a separation arrangement outlet region for discharging water from the water-collecting volume.

11. A fuel cell system comprising:
at least one fuel cell having an anode section to be supplied with a hydrogen-comprising anode gas and a cathode section to be supplied with oxygen-including cathode gas; and,
a fuel cell exhaust gas installation including:
a mixing arrangement for collecting fuel cell exhaust gas emitted from at least one fuel cell of a fuel cell system and for collecting a mixed gas and for producing a mixture of fuel cell exhaust gas and mixed gas; and,
a water separation arrangement for separating water condensed from said mixture and for discharging said mixture;
said water separation arrangement being disposed at least one of in an area of the mixing arrangement and downstream of said mixing arrangement; and,
wherein said mixing arrangement for collecting fuel cell exhaust gas discharged at the cathode section of the at least one fuel cell is connected to the cathode section.

12. A method for reducing the water content in a fuel cell exhaust gas produced in a fuel cell system, the method comprising the steps of:
a) introducing a mixed gas into the fuel cell exhaust gas and producing a mixture of fuel cell exhaust gas and mixed gas;
b) separating water from the mixture; and,
c) discharging the mixture, from which the water has been removed during step b), into the environment.

13. The method of claim 12, wherein step a) comprises supplying the fuel cell exhaust gas to a mixing volume of a mixing arrangement and supplying the mixed gas to the mixing volume.

14. The method of claim 12, wherein step b) comprises collecting water condensed from the fuel cell exhaust gas in a water-collecting volume and discharging the water collected in the water-collecting volume.

15. The method of claim 12, wherein in step a), ambient air as mixed gas is mixed with the fuel cell exhaust gas.

16. The method of claim 15, wherein the ambient air is supplied via a mixed gas supply arrangement.

17. The method of claim 12, wherein the method is performed via a fuel cell exhaust gas installation which includes:
a mixing arrangement for collecting fuel cell exhaust gas emitted from at least one fuel cell of a fuel cell system and for collecting a mixed gas and for producing a mixture of fuel cell exhaust gas and mixed gas; and,
a water separation arrangement for separating water condensed from said mixture and for discharging said mixture; and,
said water separation arrangement being disposed at least one of in an area of the mixing arrangement and downstream of said mixing arrangement.

18. The fuel cell exhaust gas installation of claim 5, wherein said jet pump arrangement includes an upstream pipe section for introducing the fuel cell exhaust gas and a downstream pipe section, wherein the upstream pipe section is positioned for engaging with a downstream end region in an upstream end region of said downstream pipe section, wherein an inlet region for the mixed gas is formed between said downstream end region of the upstream pipe section and said upstream end region of said downstream pipe section.

19. The fuel cell exhaust gas installation of claim 18, wherein at least one of the following applies:
i) said upstream pipe section is tapered at the downstream end region in a direction of flow; and,
ii) the downstream pipe section is tapered at the upstream end region.

20. The fuel cell exhaust gas installation of claim 1, wherein said fuel exhaust gas installation is for a fuel cell system in a vehicle.
